(19) United States
(12) Patent Application Publication
(10) Pub. No.: US 2008/0212007 A1
(43) Pub. Date: Sep. 4, 2008

(54) Electro-Optic Lenses Employing Resistive Electrodes

(76) Inventor: Gerald Meredith, Tucson, AZ (US)

Correspondence Address: GREENLEE WINNER AND SULLIVAN P C, 4875 PEARL EAST CIRCLE, SUITE 200, BOULDER, CO, 80301, US

(21) Appl. No.: 11/846,324

(22) Filed: Aug. 28, 2007

Related U.S. Application Data
(60) Provisional application No. 60/824,325, filed on Sep. 1, 2006.

(51) Int. Cl. G02F 1/1333; G02F 1/1343

(52) U.S. Cl. 349/139; 349/200

(57) ABSTRACT

Provided is an electro-optic device comprising: a liquid crystal layer between a pair of opposing transparent substrates; a resistive patterned electrode set positioned between the liquid crystal layer and the inward-facing surface of the first transparent substrate; and a conductive layer between the liquid crystal layer and the inward-facing surface of the second transparent substrate, wherein the conductive layer and resistive patterned electrode set are electrically connected, and wherein said resistive patterned electrode set comprises one or more electrically-separated electrodes, wherein the desired voltage drop is applied across each electrode to provide the desired phase retardation profile.

### CROSS-REFERENCE TO RELATED APPLICATIONS

This application claims the benefit of U.S. Provisional Application No. 60/824,325, filed Sep. 1, 2006, which is incorporated by reference herein.

### BACKGROUND OF THE INVENTION

The present invention is in the field of optical lenses. Ophthalmic lenses with fixed focusing properties have been widely used as spectacles and contact lenses to correct presbyopia and other conditions. Ophthalmic lenses are most useful if they have adjustable focusing power (i.e., the focusing power is not static). Adjustable focusing power provides the eye with an external accommodation to bring objects of interest at different distances into focus.

Adjustable focusing power can be achieved using a mechanical zoom lens. However, the mechanical approach makes the spectacle bulky and costly. Different optical techniques have been exploited in bifocal lenses to allow both near and distance vision. For example, the user may have lenses providing different focusing power to each eye, one for near objects and the other for distant objects. Alternatively, by use of area division of the lens, bifocal diffractive lens or other division techniques, both near and distant objects are imaged onto the retina simultaneously and the brain distinguishes the images. Except for the bifocal diffractive lens, the field of view using these optical techniques is small. Furthermore, these optical techniques do not work well when the pupil is small, since the iris blocks the beam that passes through the annular portion of the lens. Another option for correction is the use of monovision lenses, where different focusing power is provided to each eye, one for near objects and the other for distant objects. However, the binocular depth perception is affected when monovision lenses are used.

Electrically switchable lenses (for example lenses having a layer of liquid crystal sandwiched between two conductive plates where the orientation of the liquid crystal changes upon application of an electric field) have been described for use in optical systems (see, for example, Kowel, Appl. Opt. 23(16), 2774-2777 (1984); Dance, Laser Focus World 28, 34 (1992)). In electrically switchable lenses, various electrode configurations have been studied, including Fresnel zone plate electrode structures (Williams, SPIE Current Developments in Optical Engineering and Commercial Optics, 1168, 352-357 (1989); McOwan, Optics Communications 103, 189-193 (1993)). However, liquid crystal lenses have not achieved commercial success due to many factors, including fabrication and operational challenges.

### SUMMARY OF THE INVENTION

Provided is an electro-optic device comprising: a liquid crystal layer between a pair of opposing transparent substrates; a resistive patterned electrode set positioned between the liquid crystal layer and the inward-facing surface of the first transparent substrate; and a conductive layer between the liquid crystal layer and the inward-facing surface of the second transparent substrate, wherein the conductive layer and resistive patterned electrode set are electrically connected, and wherein said resistive patterned electrode set comprises one or more electrically-separated electrodes, wherein the desired voltage drop is applied across each electrode to provide the desired phase retardation profile.

Also provided is a method of diffracting light comprising applying the desired voltage drop across each electrode in a patterned electrode set as described herein.

### BRIEF DESCRIPTION OF THE FIGURES

FIG. 1 shows an illustration of a liquid crystal cell.

FIG. 2 shows voltage applied across a liquid crystal cell.

FIG. 3 shows various embodiments of electrode configurations. FIG. 3A shows deposited conduction rings. FIG. 3B shows examples of engineered resistance, where (1) rings and film are formed from one material, with the film etched to a thinner thickness; (2) resistance of the film altered by dimples; (3) resistance of the film altered by holes; (4) resistance of the film altered by a lattice; and (5) a codeposition with a second (insulating) material beyond the percolation threshold (top to bottom).

FIG. 3C shows a side view of single-layer electrodes. FIG. 3D shows a side view of multi-layer electrodes.

FIG. 4 shows various voltage bus configurations. FIG. 4A shows a simple 1-bus (with direct connections to rings on the same layer or by vias). FIG. 4B shows a commensurate structure (electrodes are connected in a repeated pattern to independent buses, which allows focal change by shunting). FIGS. 4C and 4D show incommensurate configuration where each electrode has a dedicated bus. FIG. 4C shows an independent split-bus, which allows connection in a single-layer structure.

FIG. 4D shows a normal bus configuration.

FIG. 5 shows bus-line-to-ring connections which are interdigitated (same layer). Other bus-line-to-ring connections include vias (holes through insulating layers filled with conducting material); and bridges/subways (bus lines run over/under an insulating layer separating the line from electrodes until the location of a connection need where the insulating layer is removed to allow contact with the conducting ring) (not shown). Vias and bridges/subways allow the use of unbroken electrodes (annulae and rings).

### DETAILED DESCRIPTION OF THE INVENTION

The following description provides non-limiting details of constructing the electro-optic lenses of the present invention. This invention provides electro-optic lenses filled with liquid crystal material that can be realigned in an electric field. The lenses function as diffractive-optical-elements (DOE). DOE are the result of applying voltages across a thin liquid-crystal layer which responds by altering the director-orientation field and creates nonuniform refractive-index patterns which then lead to a nonuniform phase-transmission-function (PTF) across the face of the cell. In the invention herein, accurate control of the PTF to create the desired DOE is achieved by applying the desired voltage drop across the resistive patterned electrode set.

As used herein, “resistive patterned electrode set” is one or more areas of electrically conductive material (electrodes) that are electrically separated from each other and to which a desired voltage drop can be applied. If there are two or more electrodes in a resistive patterned electrode set, the electrodes are separated by insulating material, such as SiO₂, or other materials known in the art. The electrodes in a resistive patterned electrode set can be configured in any desired configuration, including concentric annular rings, which may contain one or more voltage connections. The electrodes in a resistive patterned electrode set can be positioned on one horizontal plane, separated by insulating material, or can be on one or more different horizontal planes, each electrode and each plane separated by insulating material. Some non-limiting examples are shown in the Figures. As used herein, “concentric” or “annular” indicates that electrodes are non-overlapping, substantially ring-like with different radii. “Substantially” when referring to ring-like is intended to indicate that the ring may not be complete, for example, when electrical contacts are made, or that the ring-like structure may not form a perfect geometric form of a ring, but that the overall effect is more nearly a ring than not.

As used herein, “desired voltage drop” is the voltage drop across the resistive patterned electrode set that provides the desired voltage behavior across the resistive patterned electrode set.

The electro-optic lens used in the present invention is a diffractive lens using a resistive patterned electrode set to produce the desired distribution of phase retardations that allows the lens to function as a zone-plate lens. Diffractive lenses are known in the art. The function of a diffractive lens is based on near-field diffraction by a Fresnel zone pattern. Each point emerging from the structure serves as an emitter of a spherical wave. The optical field at a particular observing point is a summation of the contributions of the emitted spherical waves over the entire structure. Constructive interference of the spherical waves coming from the various points creates a high intensity at the observation point, corresponding to a high diffraction efficiency.

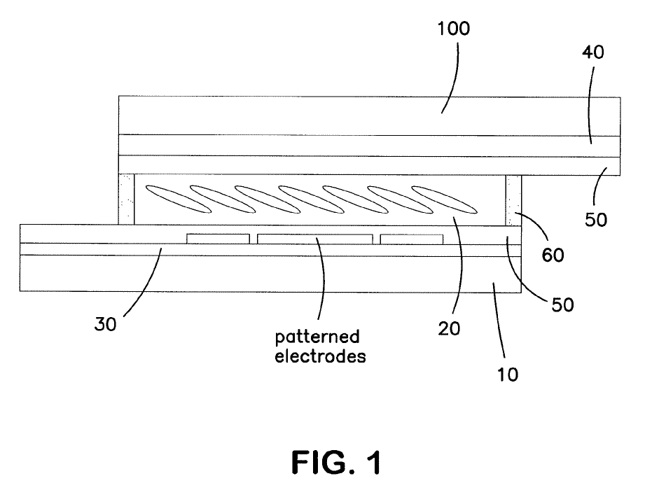

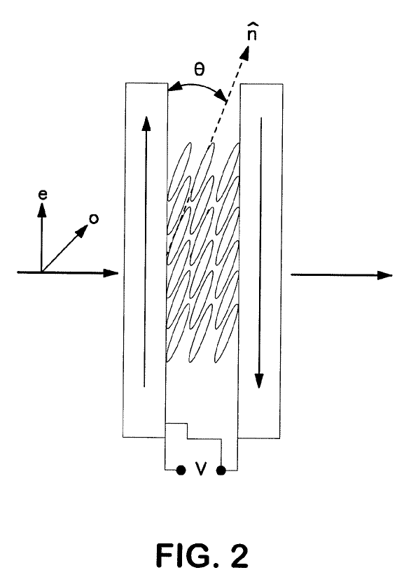

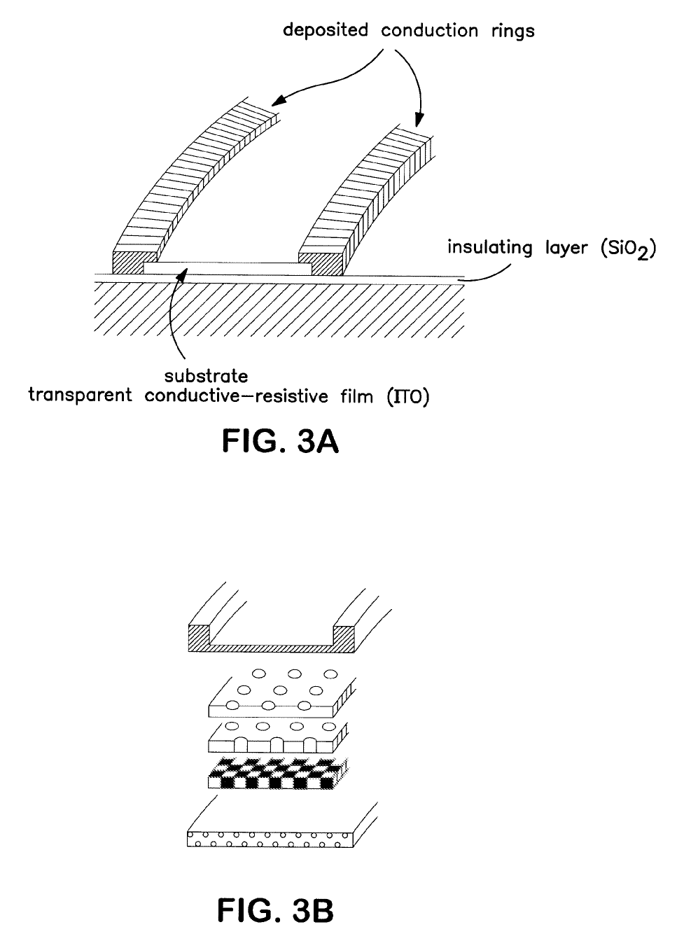

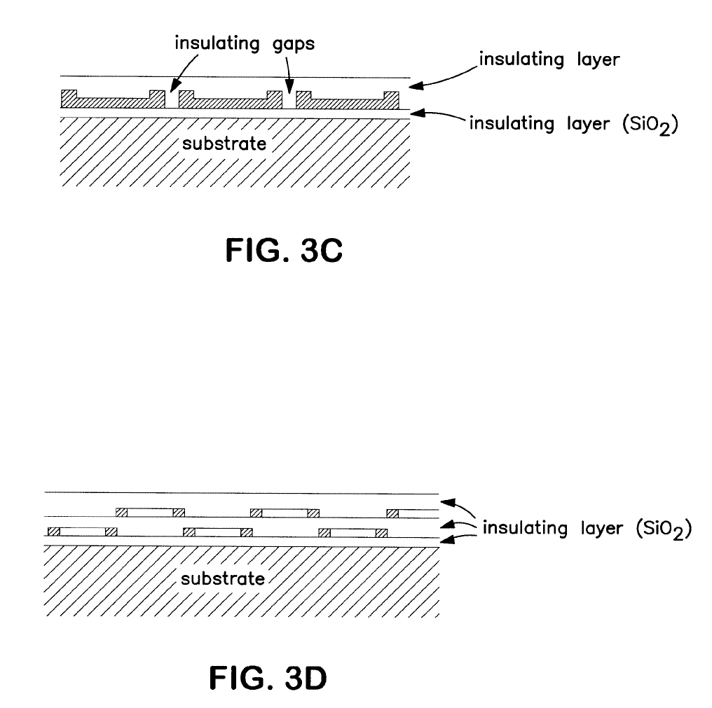

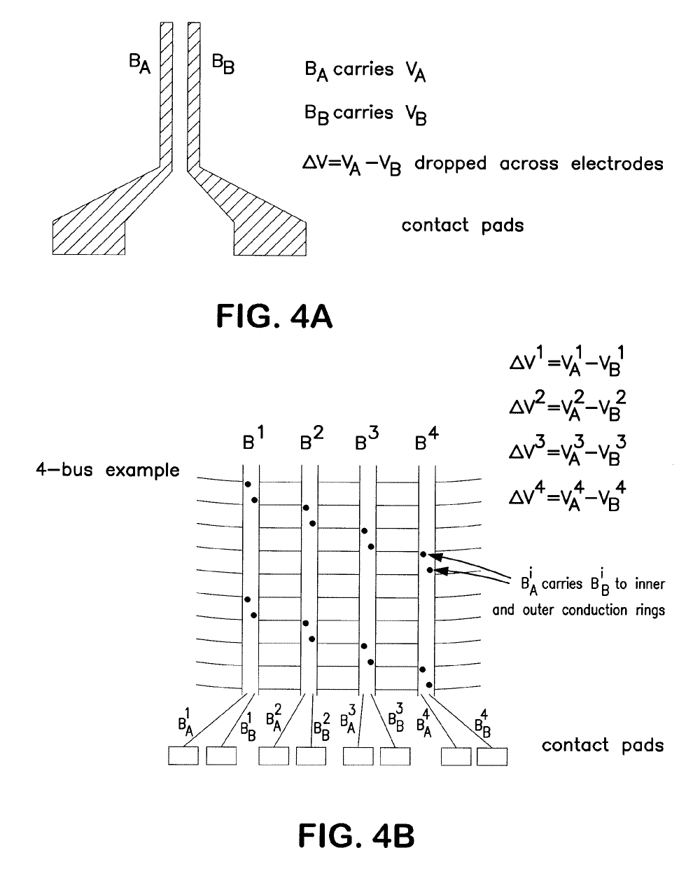

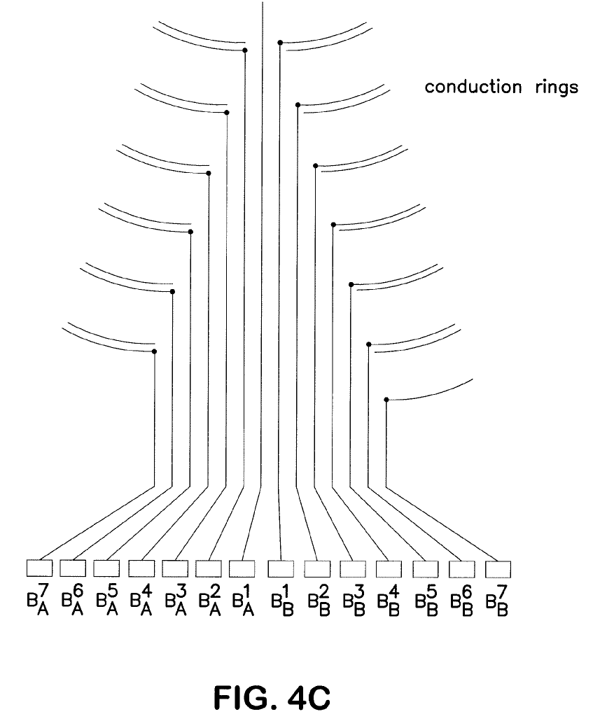

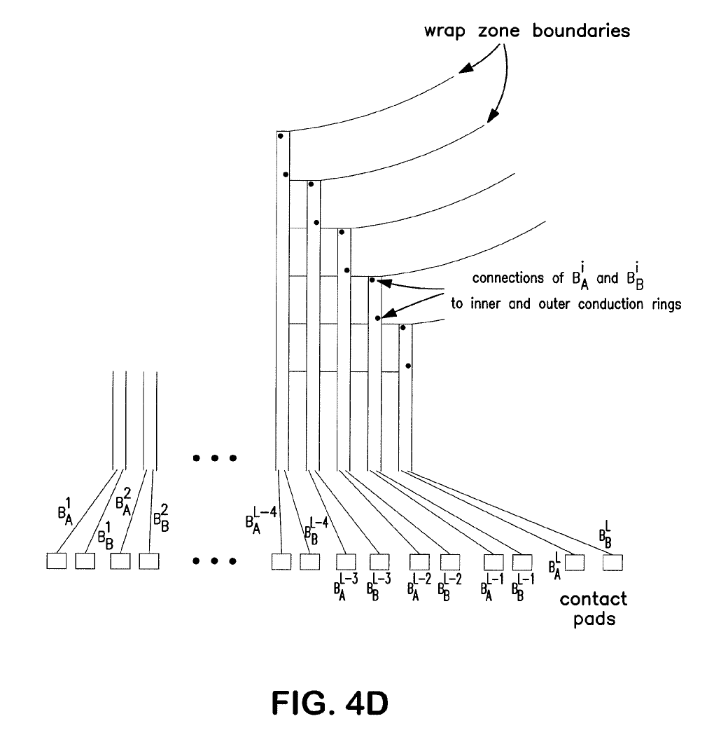

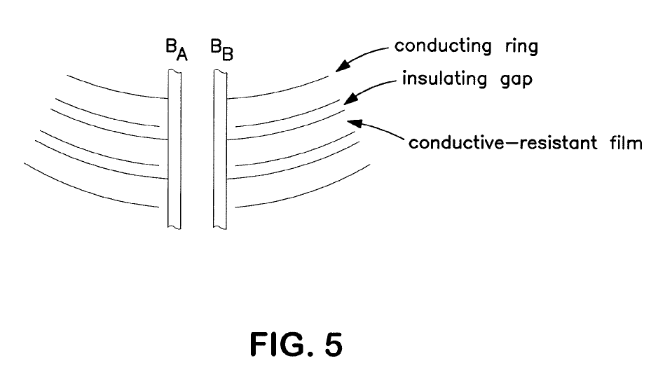

Liquid crystal cells are known in the art. All art-known cell configurations and operations of liquid crystal cells are incorporated by reference to the extent they are not incompatible with the disclosure herewith. As one example, consider an electro-active liquid crystal cell, as shown in FIG. 1, where liquid crystal material (20) is sandwiched between two substrates (100, 10) that have conductive inner surfaces (40, 30). The substrates can be any material that can provide desired optical transmission and can function in the devices and methods described herein, such as quartz, glass or plastic, as known in the art. Conductive layer 30 is patterned with a resistive patterned electrode set to provide the desired diffraction pattern. In FIG. 1, the resistive patterned electrode set shows two electrodes. The resistive patterned electrode set is fabricated by photolithographic processing of a conductive layer deposited on a glass substrate, or other techniques, as known in the art. Conductive layer 40 is not patterned. The conductive material used for the conductive layers may be any suitable material, including those specifically described herein, and other materials known in the art. It is preferred that the conductive material be transparent, such as indium oxide, tin oxide or indium tin oxide (ITO). The thickness of each conducting layer is typically between 30 nm and 200 nm. The layer must be thick enough to provide adequate conduction, but it is preferred the layer not be so thick as to provide excess thickness to the overall lens structure. The substrates are kept at a desired distance with spacers (60), or other means known in the art. Spacers may be any desired material such as Mylar, glass or quartz, or other materials useful to provide the desired spacing. In order to achieve efficient diffraction the liquid crystal layer must be thick enough to provide one wave of activated retardation (d>λ/δn˜2.5 μm, where δn is the birefringence of the liquid crystal media), but thicker liquid crystal layers help to avoid saturation phenomena. Disadvantages of thicker cells include long switching times (varying as d²) and loss of electro-optic feature definition. In particular embodiments, the transparent substrates are spaced between three and 20 microns apart, and all individual values and ranges therein. One useful spacing is 5 microns. The surfaces of the substrates may be coated with an alignment layer (50), such as polyvinylalcohol (PVA) or nylon 6,6 which is treated by rubbing to give a homogeneous molecular orientation. It is preferred that the alignment layer on one substrate is rubbed antiparallel from the alignment layer on the other substrate as shown by the arrows in FIG. 2. This allows proper alignment of the liquid crystal, as known in the art.

Voltage is applied to the resistive patterned electrode set and conductive layer using means known in the art. A voltage is applied to the inner conductive surfaces of the substrates as shown in FIG. 2. Both terminals of the power source must be connected to the patterned electrodes since the voltage is ohmically dropped across the electrodes. The unpatterned conductive layer (40 in FIG. 1) serves as ground. In one embodiment of the present invention, one driver circuit is attached to the conductive layer and a separate driver circuit is attached to the resistive patterned electrode set. Electrical contacts can be made to the electrodes using thin wires or conductive strips at the edge of the lens, or by a set of conducting vias down the lens, as known in the art. The voltages supplied to the conductive layer and resistive patterned electrode set are dependent on the particular liquid crystal used, the thickness of the liquid crystal in the cell, the desired optical transmission, and other factors, as known in the art. The actual voltages used to produce the desired voltage drop can be determined by one of ordinary skill in the art without undue experimentation using the knowledge of the art and the disclosure herein. It is known in the art that various methods of controlling all aspects of the voltage applied to electrodes can be used, including a processor, a microprocessor, an integrated circuit, and a computer chip.

As used herein, “layer” does not require a perfectly uniform film. Some uneven thicknesses, cracks or other imperfections may be present, as long as the layer performs its intended purpose, as described herein.

Zone-plate lenses activated by the application of specific voltages to capacitive electrode structures are known. In conventional capacitive zone-plate lenses, voltages are applied individually to many small discrete annular electrodes to create a stepped-phase zone-plate. In the present invention, voltage is smoothly dropped in an ohmic fashion along fewer (and larger) annular resistive electrodes (forming a resistive patterned electrode set), providing ease of fabrication and operation, since there are fewer electrodes that require control electronics. In one embodiment, the resistive electrodes are formed from a single layer of indium tin oxide (ITO) (preferably high-resistivity ITO).

Diffraction efficiency into the desired focusing order is high in the present invention due to the close correspondence of voltage profiles to desired phase retardation curves. If required, systematic errors can be reduced by use of etch-textures in the electrodes, that is, by “resistance engineering” (as known in the art).

Although Applicant does not wish to be bound to theory, additional description is provided to assist in understanding the invention.

In the present invention, thicker liquid-crystal layers can be used than using capacitance. This allows simultaneous phase-wrapping of different orders for three or more visible-light wavelength regions. A simple thin-film electro-optic lens requires phase retardation (Δφ) (ignoring higher-order terms) that depends quadratically on radial distance from the lens axis (r). In the description below, u=r².

Δφ32 ar²=au (1)

In thin films the controllable retardation is less than that required for the functioning of a lens of reasonable size. The retardation curve can be “wrapped” by integer multiples of 2π. It is convenient and orderly to do this at periodic values of u, producing a circular, radially linearly-stepped grating. Permanent zone-plate lenses are well known. One can approximate the retardation curves with steps of equal size in u which yields the well known sine dependence of diffraction efficiency in the “design” focusing-order.

### Resistance

In this invention, the drop of voltage in the resistive patterned electrode set is used to establish the desired optical phase retardation profile instead of the stepped function known for use in capacitive lenses. The resistance of annular slabs of uniform resistive material approximate the “ideal” optical phase retardation profile. If desired, the film can be textured to locally modify the resistance, as known in the art.

The resistance R(r₁, r₂) between two perfectly conducting concentric cylinders with radii r₁>r₂ defining an annular structure in a film or slab of material of uniform thickness t with resistivity ρ can be derived from the differential relationship (t is thickness):

dR=(ρ/2πt)(dr/r) (2)

R(r₁,r₂)=(ρ/2πt)ln [r₁/r₂] (3a)

R(u₁,u₂)=(ρ/4πt)ln [u₁/u₂] (3a)

This is approximately the situation for highly conducting rings deposited on a film of a transparent conducting material such ITO.

### Application to Electro-Optic Lenses

In electro-optic lenses, a thin film of liquid crystal is stressed by the voltage difference between two electrodes on opposite sides of the film, at least one of which has been patterned to allow application of voltages which create a distribution of phase retardations that function as a zone-plate lens. In the present invention, a smoothly varying voltage profile is established along a resistive electrode in the resistive patterned electrode set between two highly-conducting connections from the voltage source to the ring. (More connections allow for insertion of intermediate highly-conducting rings to “pin” voltages at specific values along the electrode, if desired). Total current I is injected across the electrode. The radial voltage distribution will mimic the resistance radial distribution of Eqs. (3) (r_{c} is the location of a charge injecting ring):

V(r,r_{c})=IR(r,r_{c})=(Iρ/2πt)ln [r/r_{c}] (4a)

V(u,u_{c})=IR(u,u_{c})=(Iρ/4πt)ln [u/u_{c}] (4b)

If the back electrode is unpatterned and at ground potential, then Eqs. (4) represent the stress-inducing voltage drop across the liquid-crystal film.

It is desired to set the parameters so as to minimize the power required from the electronics drivers and to avoid RC time constants that reduce voltage modulation on the electrodes. Clearly this suggests low-frequency driver frequencies, but they must remain above a value corresponding to liquid-crystal director reorientation times. These determinations are easily performed by one having ordinary skill in the art, without undue experimentation.

An insulating gap between successive annular electrodes is needed. Only one gap per phase-wrap is needed. It is located at the phase wrap, regardless of the integral multiple of 2π in the phase-wrap. In these gaps the voltage applied is not high enough to reorient the liquid crystal and so the liquid crystal adopts the sub-threshold configuration. This information can be included in the electrode design; since this is the correct retardation at this location (in the usual capacitive zone-plate configuration), the electrode can just pick up the work of setting the retardation at a larger value of r at a higher voltage value.

### Voltage and Phase Curve Correspondences

If the cell is operated in the quasilinear region of the liquid-crystal response curve as known in the art (e.g. by using thicker films or operating with low phase-wraps), there is a good correlation between induced phase-retardation and the perfect zone-plate lens. The natural logarithm of Equation (4b) can resemble the line of Equation (1) due to (A) the automatic resynchronization of the phase retardations (usually at zero value) at each wrap and (B) the adjustment of the magnitude of I in each electrode because, even though the resistance changes in successive electrodes, the boundary conditions are set by the terminal voltages, which would usually be the same for all electrodes. In the first zone, Equation (4b) is not ideal. This fact can be ignored since the first zone may be only a few percent of the field, or if required or desired, a partial-domain curve can be inserted in the cell, or an intermediate electrode can be inserted into the cell, or the resistance of the electrode can be tailored by etching, as known in the art. The mathematical function of Equation (4b) has a consistent curvature. The magnitude of this curvature is very small after only a few phase wraps.

The calculated average phase-retardation error (expressed as percentage of the total phase wrap), including the systematic error due to curvature—which is approximately half of the error, is {5.8, 3.3, 2.4, 1.8, 1.3, 0.8, and 0.4} in the wrap-zones following wrap number {1, 2, 3, 4, 5, 10, and 20}, respectively, using the present invention. This is far and away superior to the calculated values {12.5, 6.3, 3.1, or 1.6} in the {2, 4, 8 or 16} step approximations, respectively, in the stepped-phase capacitive case; these values are independent of location, and do not contain systematic offset error. Clearly, a resistive lens using the simple voltage-pinned, segment-wise approximation of the perfect zone-plate lens is very good in the case of low-magnitude phase wraps. Since the relative error depends on radius, larger lenses work well for higher-magnitude phase wraps.

### Chromatic Distortion Improvement

Focusing with zone-plates is highly chromatic. It is chromatic with respect to (a) focal length in the design diffraction order, and (b) variation of efficiency of diffractions into that order.

The first factor can be seen from the equation for the usual location of the wrap radii (the i^{th} wrap of magnitude 2 μm, m is an integer, f is the desired focal length, λ is the design wavelength):

rᵢ=[2im(λf)]^{1/2} (5a)

uᵢ=2im(λf) (5b)

The second factor can be seen from the dependence of induced phase shift (Δφ) on thin film properties (t is the thickness of the film, λ is the design wavelength, and n is an integer):

Δφ=2πΔn(t/λ) (6)

From Eqs. (5) it can be seen that for spatially-fixed wraps, (λ f) appears to be fixed as a constant, and therefore f is inversely proportional to λ. This represents a serious dispersion of focusing power over the visible wavelength region. Efficiency of diffraction into this (geometrically/fabrication-determined) focusing order will depend on the shape of phase profile within the wrap zones. One indication of the perfection is that on the two sides of the wrap point Eq. (6) must differ by 2 μm. An has only a weak dispersion across the visible wavelength region, but (t/λ) will vary significantly. Therefore only one wavelength will cause Eq. (6) to equal 2 πm; shorter wavelengths will accrue too much and longer wavelengths too little change in retardation. With large enough electro-optic phase throw in a film, several values of m can be achieved, so that different wavelengths will have highest diffraction efficiencies into different diffraction orders.

Further, for each m, the wavelength λₘ satisfying the 2πm requirement satisfies the relationship:

mλm=Δnt (7)

which when inserted into e.g. Eqs. (5b) predicts that the focal length at that wavelength fₘ is

fₘ=uᵢ(2iΔnt). (8)

Eq. (8) shows that in addition to the efficiency being maximized at the λₘ, disregarding the weak dispersion of Δn, the focal powers of the dominant diffraction orders for all m are identical. Thus the huge dispersion over the whole visible range which occurs when there is only diffraction via a fixed wrap-order is reduced. There are now several wavelengths (related by ratios of integers m′/m) which maximally diffract with identical focal power. There is still dispersion of f, but as λ moves from λₘ toward λ_{m±1}. If one designs for 2πn wrapping at 550 nm, one can calculate the satellite co-focusing wavelengths. To realize this situation one must be able to execute an induced retardation of at least 2πn@550 nm. For this there is minimum required thickness of film tₘᵢₙ (in microns) corresponding to a maximum electro-optic Δn−0.2 (corresponding to many liquid crystals). Obviously, significantly thicker films are required to work in the quasilinear regime.

| n | λₙ₊₂ | λₙ₊₁ | λₙ | λₙ₋₁ | λₙ₋₂ | tₘᵢₙ |
|---|---|---|---|---|---|---|
| 4 | | 440 | 550 | 733 | | 11 |
| 5 | | 458 | 550 | 688 | | 14 |
| 6 | | 471 | 550 | 660 | | 17 |
| 7 | 428 | 481 | 550 | 642 | 770 | 19 |
| 8 | 440 | 489 | 550 | 629 | 733 | 22 |
| 9 | 450 | 495 | 550 | 619 | 707 | 25 |
| 10 | 458 | 500 | 550 | 611 | 688 | 28 |

### Variation of Focal Power

It is possible to vary the focal power by applying different voltages to some or all of the electrode connections. There are two types of power alteration: commensurate and incommensurate. In both cases the phase wraps occur at the electrode terminae. In commensurate focal-power adjustment, periodicity of the phase-retardation in the variable u is maintained by keeping terminae connections linked (e.g. shunted). The focal power is altered as the electrodes are powered identically. Incommensurate power variation requires many more electrodes and voltages; one simply drops multiples of 2π off of a linear (in u) function as is convenient. The slope of this line determines the power of the lens. In either method the above described improvement in chromatic distortion may be incorporated.

### Fabrication Reliability and Simplicity

In the resistive approach only two electrical connections are required for each wrap-zone. If one is willing to give up a small area on the plane of the electrodes, the two buses can come up through a slot breaking the circles into large arcs and the electrodes can be interdigitally connected. Since the product must be as close to electrically perfect over the whole area of the lens as possible, the fewer etched or deposited features, the better.

### High Efficiency

The patterned resistive electrode set approach can approach nearly unity efficiency. As shown earlier, the nature of the wrapping and electro-optic driving force high compliance in uniform, untextured, resistive materials.

### Larger Lens Size

A practical limitation to the creation of larger lenses is that the size of zones scales as r⁻¹ while the number of zones scales as r². In the resistive electrode approach, the electrode spans the width of the wrap-zone. For a 4 cm lens, that size is 25 μm for m=1, 50 μm for m=2, etc. The fabrication restrictions for these lenses are associated with insulating gaps and conducting-ring connections. These restrictions can be improved by using larger values of m.

### Greater Range of Power

The size of features in zone-plate lenses scale f^{1/2}, according to Eq. (5a). The same lowering of fabrication requirements that enables larger lens sizes also allows for production/operation of much stronger focusing lenses.

### Chromatic Dispersion Improvement

Due to the relative ease of fabricating high-m structures, the resistive-electrode approach is simply adapted to the method of improving chromatic dispersion outlined above.

### Liquid Crystals

The liquid crystal(s) used in the invention include those that form nematic, smectic, or cholesteric phases that possess a long-range orientational order that can be controlled with an electric field. It is preferred that the liquid crystal have a wide nematic temperature range, easy alignability, low threshold voltage, large electro-optic response and fast switching speeds, as well as proven stability and reliable commercial availability. In one preferred embodiment, E7 (a nematic liquid crystal mixture of cyanobiphenyls and cyanoterphenyls sold by Merck) is used. Examples of other nematic liquid crystals that can be used in the invention are: pentyl-cyano-biphenyl (5CB), (n-octyloxy)-4-cyanobiphenyl (80CB). Other examples of liquid crystals that can be used in the invention are the n=3, 4, 5, 6, 7, 8, 9, of the compounds 4-cyano-4-n-alkylbiphenyls, 4-n-pentyloxy-biphenyl, 4-cyano-4″-n-alkyl-p-terphenyls, and commercial mixtures such as E36, E46, and the ZLI-series made by BDH (British Drug House)-Merck.

Electroactive polymers can also be used in the invention. Electroactive polymers include any transparent optical polymeric material such as those disclosed in “Physical Properties of Polymers Handbook” by J. E. Mark, American Institute of Physics, Woodburry, N.Y., 1996, containing molecules having unsymmetrical polarized conjugated p electrons between a donor and an acceptor group (referred to as a chromophore) such as those disclosed in “Organic Nonlinear Optical Materials” by Ch. Bosshard et al., Gordon and Breach Publishers, Amsterdam, 1995. Examples of polymers are as follows: polystyrene, polycarbonate, polymethylmethacrylate, polyvinylcarbazole, polyimide, polysilane. Examples of chromophores are: paranitroaniline (PNA), disperse red 1 (DR 1), 3-methyl-4-methoxy-4′-nitrostilbene, diethylaminonitrostilbene (DANS), diethyl-thio-barbituric acid. Electroactive polymers can be produced by: a) following a guest/host approach, b) by covalent incorporation of the chromophore into the polymer (pendant and main-chain), and/or c) by lattice hardening approaches such as cross-linking, as known in the art. Polymer liquid crystals (PLCs) may also be used in the invention. Polymer liquid crystals are also sometimes referred to as liquid crystalline polymers, low molecular mass liquid crystals, self-reinforcing polymers, in situ-composites, and/or molecular composites. PLCs are copolymers that contain simultaneously relatively rigid and flexible sequences such as those disclosed in “Liquid Crystalline Polymers: From Structures to Applications” by W. Brostow; edited by A. A. Collyer, Elsevier, New-York-London, 1992, Chapter 1. Examples of PLCs are: polymethacrylate comprising 4-cyanophenyl benzoate side group and other similar compounds.

Polymer dispersed liquid crystals (PDLCS) may also be used in the invention. PDLCs consist of dispersions of liquid crystal droplets in a polymer matrix. These materials can be made in several ways: (i) by nematic curvilinear aligned phases (NCAP), by thermally induced phase separation (TIPS), solvent-induced phase separation (SIPS), and polymerization-induced phase separation (PIPS), as known in the art. Examples of PDLCs are: mixtures of liquid crystal E7 (BDH-Merck) and NOA65 (Norland products, Inc. NJ); mixtures of E44 (BDH-Merck) and polymethylmethacrylate (PMMA); mixtures of E49 (BDH-Merck) and PMMA; mixture of the monomer dipentaerythrol hydroxy penta acrylate, liquid crystal E7, N-vinylpyrrolidone, N-phenylglycine, and the dye Rose Bengal.

Polymer-stabilized liquid crystals (PSLCs) can also be used in the invention. PSLCs are materials that consist of a liquid crystal in a polymer network in which the polymer constitutes less than 10% by weight of the liquid crystal. A photopolymerizable monomer is mixed together with a liquid crystal and an UV polymerization initiator. After the liquid crystal is aligned, the polymerization of the monomer is initiated typically by UV exposure and the resulting polymer creates a network that stabilizes the liquid crystal. For examples of PSLCs, see, for instance: C. M. Hudson et al. Optical Studies of Anisotropic Networks in Polymer-Stabilized Liquid Crystals, Journal of the Society for Information Display, vol. 5/3, 1-5, (1997), G. P. Wiederrecht et al, Photorefractivity in Polymer-Stabilized Nematic Liquid Crystals, J. of Am. Chem. Soc., 120, 3231-3236 (1998).

Self-assembled nonlinear supramolecular structures may also be used in the invention. Self-assembled nonlinear supramolecular structures include electroactive asymmetric organic films, which can be fabricated using the following approaches: Langmuir-Blodgett films, alternating polyelectrolyte deposition (polyanion/polycation) from aqueous solutions, molecular beam epitaxy methods, sequential synthesis by covalent coupling reactions (for example: organotrichlorosilane-based self-assembled multilayer deposition). These techniques usually lead to thin films having a thickness of less than about 1 μm.

The devices of the invention can be used in a variety of applications known in the art, including lenses used for human or animal vision correction or modification. The lenses can be incorporated in spectacles, as known in the art. Spectacles can include one lens or more than one lens. The devices may also be used in display applications, as known to one of ordinary skill in the art without undue experimentation. The lenses of the invention can be used with conventional lenses and optics.

Every device or combination of components described or exemplified can be used to practice the invention, unless otherwise stated. Additional components such as drivers to apply the voltages used, controllers for the voltages and any additional required optical components are known to one of ordinary skill in the art and incorporated without undue experimentation. Specific names of compounds are intended to be exemplary, as it is known that one of ordinary skill in the art can name the same compounds differently.

When a compound is described herein such that a particular isomer or enantiomer of the compound is not specified, for example, in a formula or in a chemical name, that description is intended to include each isomers and enantiomer of the compound described individual or in any combination. One of ordinary skill in the art will appreciate that methods, device elements, starting materials, and fabrication methods other than those specifically exemplified can be employed in the practice of the invention without resort to undue experimentation. All art-known functional equivalents, of any such methods, device elements, starting materials, and fabrication methods are intended to be included in this invention. Whenever a range is given in the specification, for example, a thickness range or a voltage range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed and described. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention.

In general the terms and phrases used herein have their art-recognized meaning, which can be found by reference to standard texts, journal references and contexts known to those skilled in the art. Specific definitions are provided to clarify their specific use in the context of the invention. All patents and publications mentioned in the specification are indicative of the levels of skill of those skilled in the art to which the invention pertains.

One skilled in the art would readily appreciate that the present invention is well adapted to carry out the objects and obtain the ends and advantages mentioned, as well as those inherent therein. The devices and methods and accessory methods described herein as presently representative of preferred embodiments are exemplary and are not intended as limitations on the scope of the invention. Changes therein and other uses will occur to those skilled in the art, which are encompassed within the spirit of the invention, are defined by the scope of the claims.

All references cited herein are hereby incorporated by reference to the extent that there is no inconsistency with the disclosure of this specification. Some references provided herein are incorporated by reference herein to provide details concerning additional device components, additional liquid crystal cell configurations, additional patterns for patterned electrodes, additional methods of analysis and additional uses of the invention.

Although the description herein contains many specificities, these should not be construed as limiting the scope of the invention, but merely providing examples of some of the presently preferred embodiments of the invention. The invention is not limited in use to spectacles. Rather, as known by one of ordinary skill in the art, the invention is useful in other fields such as telecommunications, optical switches and medical devices. Any liquid crystal or mixture of liquid crystals that provides the desired phase transmission function at the desired wavelength is useful in the invention, as known by one of ordinary skill in the art. Determining the proper voltage and applying the proper voltage to liquid crystal materials to produce a desired phase transmission function is known in the art.

### REFERENCES

G. Smith et al., The eye and visual optical instruments, Cambridge University Press, 1997.
G. Vdovin et al., On the possibility of intraocular adaptive optics, Opt. Express 11:810-817, 2003.
G. Williams et al., Electrically controllable liquid crystal Fresnel lens, Proc. SPIE 1168:352-357, 1989.
J. S. Patel et al., Electrically controlled polarization-independent liquid-crystal Fresnel lens arrays, Opt. Lett. 16:532-534, 1991.
B. Dance, Liquid crystal used in switchable Fresnel lens, Laser Focus World 28:34, 1992.
M. C. K. Wiltshire, Non-display applications of liquid crystal devices, Geo J. Research 10:119-125, 1993.
H. Ren et al., Tunable Fresnel lens using nanoscale polymer-dispersed liquid crystals, Appl. Phys. Lett. 83:1515-1517, 2003.
C. W. Fowler et al., Liquid crystal lens review, Ophthal. Physiol. Opt. 10:186-194, 1990.
J. A. Futhey, Diffractive bifocal intraocular lens, Proc. SPIE 1052:142-149, 1989.
S. Sato et al., Variable-focus liquid crystal Fresnel lens, Jpn. J. Appl. Phys. 24:L626-L628, 1985.
L. G. Commander et al., Variable focal length microlenses, Opt. Commun. 177:157-170, 2000.
S. T. Kowel et al., Focusing by electrical modulation of refraction in a liquid crystal cell, Appl. Opt. 23:278-289, 1984.
A. Nouhi et al., Adaptive spherical lens, Appl. Opt. 23:2774-2777, 1984.
A. F. Naumov et al., Liquid-crystal adaptive lenses with modal control, Opt. Lett. 23:992-994, 1998.
M. Y. Loktev et al., Wave front control systems based on modal liquid crystal lenses, Rev. Sci. Instrum. 71:3190-3297, 2000.
N. A. Riza et al., Three-terminal adaptive nematic liquid-crystal lens device, Opt. Lett. 19:1013-1015, 1994.
P. W. McOwan et al., A switchable liquid crystal binary Gabor lens, Opt. Commun. 103:189-193, 1993.
S. Masuda et al., Liquid-crystal microlens with a beam-steering function, Appl. Opt. 36:4772-4778, 1997.
B. Kress et al., Digital Diffractive Optics, John Wiley & Sons Ltd., 2000. US application publication US2005/0073739 (Apr. 7, 2005)

I claim:

1. An electro-optic device comprising:
a liquid crystal layer between a pair of opposing transparent substrates;
a resistive patterned electrode set positioned between the liquid crystal layer and the inward-facing surface of the first transparent substrate;
and a conductive layer between the liquid crystal layer and the inward-facing surface of the second transparent substrate, wherein the conductive layer and resistive patterned electrode set are electrically connected, and wherein said resistive patterned electrode set comprises one or more electrically-separated electrodes, wherein the desired voltage drop is applied across each electrode to provide the desired phase retardation profile.

2. The device of claim 1, wherein the resistive patterned electrode set comprises two or more electrically-separated concentric electrodes.

3. The device of claim 1, wherein the liquid crystal is E7.

4. The device of claim 1, wherein the transparent substrates are glass.

5. The device of claim 1, wherein the transparent substrates are plastic.

6. The device of claim 1, wherein the electrodes and conductive layer are indium-tin-oxide.

7. The device of claim 1, further comprising an alignment layer surrounding the liquid crystal layer.

8. The device of claim 7, wherein the alignment layer is polyvinyl alcohol.

9. The device of claim 7, wherein the alignment layer is nylon 6,6.

10. The device of claim 1, wherein the transparent substrates are between about 3 and about 20 microns apart.

11. The device of claim 10, wherein the transparent substrates are between about 3 and about 8 microns apart.

12. A method of diffracting light comprising:
providing a liquid crystal layer between a pair of opposing transparent substrates, a resistive patterned electrode set positioned between the liquid crystal layer and the inward-facing surface of the first transparent substrate; a conductive layer between the liquid crystal layer and the inward-facing surface of the second transparent substrate, said conductive layer electrically connected to the resistive patterned electrode set;
applying a sufficient voltage to the resistive patterned electrode set to provide the desired amount of optical transmission change in the liquid crystal.
